(19) United States
(12) Patent Application Publication
(10) Pub. No.: US 2010/0043834 A1
(43) Pub. Date: Feb. 25, 2010

(54) DISHWASHER WITH A HANDLING DEVICE AT THE DISH DEPOSIT POINT

(76) Inventor: Stefan SCHERINGER, Offenburg (DE)

Correspondence Address: Muncy, Geissler, Olds & Lowe, PLLC, P.O. BOX 1364, FAIRFAX, VA, 22038-1364, US

(21) Appl. No.: 12/546,197

(22) Filed: Aug. 24, 2009

(30) Foreign Application Priority Data
Aug. 22, 2008 (DE) DE 102008039196.4

(51) Int. Cl. B08B 3/00

(52) U.S. Cl. 134/25.2; 134/56 D

(57) ABSTRACT

A cleaning apparatus for cleaning washware is provided. The cleaning apparatus can be used, in particular, for cleaning dishes. The cleaning apparatus can comprises at least one automatic conveyor-type cleaning machine, in particular a conveyor-type dishwasher. The automatic conveyor-type cleaning machine has at least one transportation apparatus and is designed to transport the washware through at least one cleaning zone. The cleaning apparatus also has at least one handling device, in particular a robot. The handling device can be designed to at least partly automatically pick up presented washware and transfer the washware to the transportation apparatus.

This nonprovisional application claims priority under 35 U.S.C. §119(a) to German Patent Application No. DE 10 2008 039 196.4, which was filed in Germany on Aug. 22, 2008, and which is herein incorporated by reference.

### BACKGROUND OF THE INVENTION

1. Field of the Invention

The invention relates to a cleaning apparatus for cleaning washware and also to a corresponding method for loading an automatic conveyor-type cleaning machine and for cleaning washware. Cleaning apparatuses and methods of this type are used in large-scale kitchens, in particular in the area of communal feeding, for example in schools, offices, hospitals and care homes, company cafeterias or similar facilities. Such cleaning apparatuses and methods are used, in particular, for cleaning dishes, for example glasses, plates, cutlery, cups, trays or other articles which come into direct or indirect contact with articles which are suitable for use for eating and drinking. However, use of the proposed cleaning apparatus and the proposed methods is also, in principle, possible for cleaning other types of washware.

2. Description of the Background Art

In facilities for communal feeding, for example refectories in universities, company cafeterias, hospital cafeterias or similar facilities, a large quantity of washware, for example dishes, cutlery and food trays, are generally produced at the same time at peak feeding times. Therefore, used food trays, together with all other dishes and items of cutlery as well as waste on the said trays, are usually conveyed, for example with the aid of a conveyor belt, into the vicinity of a dish deposit point of a dishwasher, for example of a conveyor-type dishwasher. Conveyor-type dishwashers are known, for example, in the form of rack transportation machines or in the form of belt transportation machines. At the dish deposit point, the dishes and items of cutlery are usually removed from the trays by hand and placed onto the conveyor belt of the dishwasher or into the dish racks. This work is very monotonous and very strenuous when there is a high volume of dishes or washware, for example during the said peak times.

If there is a large quantity of washware, a single operator often cannot cope with this volume of work. For this reason, a plurality of clearing stations are generally provided at the dish deposit point, for example at the inlet zones of large washing systems, and the clearing stations are occupied by staff. However, this increases the space requirement at these inlet zones. In addition, the financial outlay for the operating company is considerably increased. Fluctuations in the volume of washware can be compensated for only with difficulty in this configuration, and generally an unnecessarily large number of staff are provided.

As an alternative, so-called fully automatic sorting machines are used in very large washing systems with very high volumes of washware. Fully automatic sorting machines of this type are designed specially for the occurring arrangement of dishes. In these systems, the trays are mechanically turned and the dishes are conducted via switch points, locks and with similar auxiliary means and methods with the aid of conveying devices of the dishwasher. However, these systems are very large, therefore require a large amount of space and are expensive to acquire. Furthermore, these systems are inflexible with regard to the type of washware encountered and the distribution of this washware on the trays. The systems are generally designed only for one specific use. Furthermore, systems of this type require a great deal of maintenance and are comparatively susceptible to faults on account of the high level of complexity.

### SUMMARY OF THE INVENTION

It is therefore an object of the present invention to provide a cleaning apparatus and methods for loading an automatic conveyor-type cleaning machine and also for cleaning washware, which cleaning apparatus and methods at least largely avoid the disadvantages of known apparatuses and methods. In particular, the intention is for the cleaning apparatus and the methods to allow a high degree of automation and at the same time to be used in a flexible manner.

A cleaning apparatus for cleaning washware is provided, which cleaning apparatus can have at least one automatic conveyor-type cleaning machine. The invention also provides a method for loading an automatic conveyor-type cleaning machine with washware. Thus, the cleaning apparatus may be designed, in particular, to carry out a method according to the invention, for example by means of one or more corresponding control systems, and the method can be carried out using a cleaning apparatus according to the invention. In this respect, reference may be made to details of the method for possible refinements of the cleaning apparatus, and vice versa.

The method serves to load an automatic conveyor-type cleaning machine with washware. Thus, loading can be understood, in general, to mean providing washware to the automatic conveyor-type cleaning machine, this loading been performed in such a way that the washware can be correctly cleaned in the automatic conveyor-type cleaning machine. In particular, loading can comprise correct presentation of the washware to a transportation apparatus of the automatic conveyor-type cleaning machine, for example with correct sorting of the washware, with correct orientation, with correct placement in compartments for specific types of washware or the like. The method can also be extended to a method for cleaning washware, by at least one cleaning step which is carried out in the automatic conveyor-type cleaning machine being added.

The proposed cleaning apparatus can be used, in particular, to clean dishes. Thus, dishes can be understood to be, as described above, articles which can come into direct or indirect contact with food and drinks which are suitable for consumption, and/or can be used for preparing such food and/or drinks. Examples of such articles include plates, chargers, bowls, cups, glasses, cutlery or trays. The washware is generally made up of a plurality of individual items, and therefore a tray which is covered with a plurality of dishes is presented, for example.

The cleaning apparatus comprises at least one automatic conveyor-type cleaning machine, in particular a conveyor-type dishwasher. This automatic conveyor-type cleaning machine comprises at least one transportation apparatus and is designed to transport the washware through at least one cleaning zone. The washware is subjected to the action of at least one cleaning fluid in this cleaning zone. A plurality of such cleaning zones may also be provided, for example a pre-clearing zone, a wash zone, a rinse zone, in particular a pump rinse zone and/or a fresh-water rinse zone or combinations of the said cleaning zones and/or further cleaning zones. Other types of zones may also be provided in the automatic conveyor-type cleaning machine, for example one or more drying zones, inlet zones, outlet zones or the like. An automatic conveyor-type cleaning machine is therefore to be understood, in general, to be an apparatus which is suitable for continuous and/or sequential use for cleaning and which has a corresponding transportation apparatus and at least one cleaning zone. In particular, this automatic conveyor-type cleaning machine can comprise at least one belt transportation and/or rack transportation dishwasher and/or a combination of such conveyor-type dishwashers and/or other conveyor-type dishwashers.

Furthermore, the cleaning apparatus comprises at least one handling device, in particular a robot. This handling device is designed to at least partly automatically pick up presented washware and transfer the said washware to the transportation apparatus. Thus, a handling device can be understood as an apparatus which is designed to pick up washware which is presented in a randomly distributed manner and to change the physical position and/or orientation of the said washware in two or three dimensions, so that, in general, it is also possible for an apparatus which presents the washware to pick up the said washware and transfer the said washware to the transportation apparatus when the presenting apparatus does not always present the washware in the same position and/or orientation but with a stochastic physical distribution and/or angular distribution. In this respect, a handling device is intended to be understood to be an apparatus which can respond flexibly to a stochastic physical distribution and/or angular distribution of the washware and nevertheless can transfer said washware to the transportation apparatus.

Therefore, the term “at least partly automatically” can be understood as meaning that not every presented item of washware has to be picked up by the handling device. For example, it is possible, as discussed in greater detail below, for a plurality of handling devices to be provided, it also being possible to use these handling devices, for example, for different types of washware. Furthermore, it is also possible to use, in addition to the at least one handling device, one or more human operators who likewise pick up presented washware and transfer the said washware to the at least one transportation apparatus and/or to other devices, for example other types of cleaning apparatuses.

However, the at least one handling device should operate automatically, in the sense that the presented washware can be picked up by the handling device without direct intervention by human operators. Therefore, the handling device is intended to automatically identify that an item of washware is presented, how and where this item of washware is positioned and is accordingly intended to pick up and transfer this item of washware to the transportation apparatus.

The cleaning apparatus may also have a feed device for feeding the washware to the automatic conveyor-type cleaning machine. By way of example, the feed device may be designed to feed the washware to a dish deposit point and/or into the vicinity of this dish deposit point of the automatic conveyor-type cleaning machine and/or to a plurality of such dish deposit points. This dish deposit point may be arranged, for example, in the region of an inlet to a conveyor-type dishwasher. Thus, the handling device can be designed to automatically pick up the washware from the feed device and to transfer the said washware to the transportation apparatus. One or more feed devices, combined with one or more transportation apparatuses, may be provided. However, as an alternative or in addition to the at least one feed device, which can operate in a fully automatic manner, other ways of providing the washware can be selected, for example additionally manual provision of the washware, for example dishes.

The feed device may comprise, for example, at least one of the following feed devices: a conveyor belt, in particular a strap belt and/or a round belt conveyor, or a chain belt, in particular a plate chain belt. However, other types of feed devices and/or combinations of the types and/or other types of feed devices are also feasible. If a conveyor belt or a chain belt is used, this conveyor belt or chain belt can be arranged, in particular, perpendicular or substantially perpendicular to a transportation direction of the at least one transportation apparatus. The at least one handling device can then be arranged, for example, in an angular region between the transportation apparatus and the conveyor belt or in a transportation direction of the feed device. In this respect, the handling device can be designed to carry out a pivoting movement, in the case of which the washware which is picked up by the feed device is pivoted about an angle, such as an angle of at least approximately 90°, in order to be able to deposit the said washware on the transportation apparatus. To this end, the handling device can comprise a pivoting shaft for example.

As described above, the cleaning apparatus can have one or more automatic conveyor-type cleaning machines. When there are a plurality of automatic conveyor-type cleaning machines, for example at least two automatic conveyor-type cleaning machines, the feed device may be designed to present washware to both automatic conveyor-type cleaning machines. It is therefore possible for the same feed device to be used in order to present washware to a plurality of automatic conveyor-type cleaning machines, for example to present a first type of washware to a first automatic conveyor-type cleaning machine and a second type of washware to a second automatic conveyor-type cleaning machine. Thus, each automatic conveyor-type cleaning machine can have at least its own associated handling device which picks up the washware presented by the feed device and transfers the said washware to the respective transportation apparatus of the respective automatic conveyor-type cleaning machine.

The handling device may be matched, in principle, to the type of presented washware. The handling apparatus can therefore have, for example, at least one of the following pick-up apparatuses for picking up the presented washware: a mechanical pick-up apparatus, in particular a grabber; a magnetic pick-up apparatus; a pneumatic pick-up apparatus, in particular at least one suction device and/or at least one suction cup. However, other types of pick-up apparatuses are also possible in principle. Irrespective of the type of pick-up apparatus provided, this pick-up apparatus can also be matched to the way in which the washware is presented. If this washware is presented, for example, substantially in one plane, for example by a transportation belt, a conveyor belt, a strap belt or the like, the pick-up apparatus may correspondingly be designed to pick up the washware in this plane or from spatial directions above this plane.

Transfer to the transportation apparatus can also be correspondingly configured. If this transportation apparatus is, for example, again configured as a flat transportation apparatus, for example in the form of a belt, a chain or similar transportation apparatuses, the said washware can again be transferred into this plane or from spatial directions above this plane. As discussed in greater detail below by way of example, the transportation apparatus may be configured, for example, as a belt transportation means and can, for example, have a plurality of compartments, lanes or the like on one belt. Accordingly, different types of washware can be associated with these compartments, lanes or similar receptacles in the transportation apparatus. Corresponding sorting or deposition into dish racks or other racks of the transportation apparatus is also possible, for example when using rack transportation dishwashers.

The handling device can be configured as a freely programmable handling device. By way of example, the handling device can have one or more control systems which can be designed centrally or else decentrally. It is also possible to completely or partly combine this at least one control system of the handling device with other types of control systems of the cleaning apparatus, as is discussed in greater detail below, likewise by way of example. The control system of the handling device is also called the device control system in the text which follows, for example to distinguish it from other types of control systems of the cleaning apparatus, for example a machine control system of the automatic conveyor-type cleaning machine. The device control system can comprise, for example, at least one data-processing apparatus, for example one or more microprocessors or the like. Furthermore, corresponding memory means can be provided, for example non-volatile or volatile memory means can be provided. Furthermore, input and output means can be provided, for example one or more displays, indicator apparatuses, keypads, touch screens, operator control knobs, acoustic indicator elements or the like.

Thus, free programmability of the handling device can be understood to mean that the handling device can be freely matched to the ambient conditions within certain limits by changing a corresponding program in the machine control system. It is therefore possible, for example, to perform adaptation in terms of the way in which the washware is presented, in terms of the type of washware itself, in terms of the way in which the washware is picked up, in terms of the orientation of the presentation apparatus in relation to the transportation apparatus and the movements which are correspondingly carried out for transfer, in terms of the type of transportation apparatus or in terms of other ambient conditions or combinations of the said and/or other types of ambient conditions. In this way, it is possible to match the cleaning apparatus flexibly to the conditions which are given at each location. In particular, it is possible to provide free programmability in terms of the movements which have to be carried out by the handling device when transferring washware to the transportation apparatus.

The handling device can be configured, in particular, as a handling device with at least two degrees of freedom for movement. Even three or more degrees of freedom can be provided. This can be ensured, for example, by the handling device comprising at least one robot, for example at least one industrial robot. The robot may be, for example, a two-axis, a three-axis or even a four- or multiple-axis robot. By way of example, this robot may be a robot with a corresponding robot arm which can be controlled on a plurality of axes. Thus, a robot can be understood to be, in general, a freely programmable and reprogrammable multifunctional manipulator which can have at least three independent axes and which is generally used to move materials, parts, tools or specific devices on programmed, variable tracks in order to perform an extremely wide variety of tasks. In the present case, this task at least partly involves automatic pick-up of the washware and transfer of the said washware to the transportation apparatus. An industrial robot is generally understood to be an automatic movement machine, which can be used universally, with a plurality of axes, it being possible to program the movements of the said robots in terms of the movement sequence and the movement paths or angles, that is to say without mechanical intervention, and which are possibly sensor-guided. The said industrial robots can be equipped with grabbers, tools or other production means and can perform handling and/or production tasks. In the present case, industrial robots of this type can be used to automatically pick up the presented washware and to transfer the said washware to the transportation apparatus.

As already mentioned in connection with the above definition of an industrial robot, the cleaning apparatus, in particular the handling device, can have at least one sensor for detecting the presented washware. Thus, a sensor can be understood, in general, to be an apparatus which is based on fundamentally any physical principles and which can detect at least one property of the washware, for example a physical and/or chemical property. By way of example, this property may comprise at least one of the following properties: position of the washware; orientation of the washware; type of washware; degree of soiling of the washware; condition of the washware; material of the washware. Other types of properties can also be detected. The at least one sensor can be used, for example, to make the handling device respond flexibly to the said properties in order to configure pick up of the washware and/or transfer of the washware to the transportation apparatus in accordance with the detected properties. The simple presence of washware can also be understood to be a property in this sense, and therefore pick-up and transfer of washware to the transportation apparatus can accordingly be started when this presence is identified. Furthermore, the at least one property of the washware can also, as will be explained in greater detail below, be forwarded to the automatic conveyor-type cleaning machine, for example a control system of the automatic conveyor-type cleaning machine, in order to adapt a cleaning process or cleaning operation in accordance with this property. As will likewise be discussed in great detail below, said property may be, for example, the degree of soiling and/or the type of washware.

As an alternative or in addition to the at least one sensor or as a constituent part of this at least one sensor, the cleaning apparatus, in particular the handling device, can also have at least one image-capturing system. This image-capturing system can be designed to identify the washware, with the cleaning apparatus being designed to control pick-up of the washware by the handling device and/or transfer of the washware to the transportation apparatus in accordance with the washware which is identified by the image-capturing system.

Thus, an image-capturing system can be understood to be, in general, a system which records one-, two- or three-dimensional image information about the presented washware, for example at regular or irregular intervals. To this end, the image-processing system can detect, by way of example, at least one optical array, for example a one-, two- or three-dimensional optical array. By way of example, cameras, such as digital cameras, can be used for this purpose, the cameras recording still images or sequences of images. These cameras may comprise, for example, CMOS and/or CCD chips and/or other types of image sensors.

Furthermore, the image-processing system can comprise at least one data-processing apparatus for processing and/or storing image information. This may also comprise, by way of example, an image-processing system which evaluates all or some of the presented optical data. This image-processing system can comprise, for example, an image-identification apparatus which is designed to detect one or more properties within the meaning of the above-described properties of the washware. It is therefore possible, for example, to detect the presence of washware, the type of washware, the orientation and/or position of the washware, the degree of soiling of the washware or similar properties or combinations of the said and/or other properties. This can be done, for example, using the image-processing system by means of pattern identification, by means of which the occurrence of specific types of patterns which are typical of a specific type of washware are, for example, deliberately sought.

In this further development of the invention, transfer of the washware to the transportation apparatus can be controlled in accordance with the washware which is identified by the image-processing system. In this aspect of the invention, it should also be mentioned that transfer of the washware is controlled in accordance with at least one property of the washware which is captured by the image-capturing system, for example the orientation and/or position of the washware. To this end, it is possible, for example, for the handling device, as soon as a position and/or orientation of the washware is identified, to control at least one pick-up apparatus, for example at least one grabber, in accordance with this identified position and/or orientation. Furthermore, the cleaning apparatus can be designed to control a cleaning operation of the washware in the automatic conveyor-type cleaning machine in accordance with the washware identified by the image-capturing system or the identified property. By way of example, this control can be performed in accordance with the degree of soiling of the washware. The cleaning operation parameters, for example the cleaning parameters of a dishwasher mode, can be adapted, for example, in accordance with the identified degree of soiling and/or the identified type of washware. It is therefore possible to adapt, for example, the belt speed of the transportation apparatus, the type and/or concentration of detergents, the cleaning temperature or the like. It is also possible to adapt parameter combinations of the said and/or other parameters of operation of the automatic conveyor-type cleaning machine.

The cleaning apparatus can comprise, as described above, one or more handling devices, in particular one or more robots. As described above, it is additionally possible to provide one or more human operators who can likewise transfer the presented washware to the transportation apparatus.

In addition, one or more image-capturing systems can also be provided. For example, each handling device can have one or more associated and dedicated image-capturing systems, or else one or more image-capturing systems can be provided in groups for a plurality of handling devices. Thus, the plurality of handling devices and/or the plurality of image-capturing systems can be controlled and/or supplied with power by a common device control system.

As described above, the at least one automatic conveyor-type cleaning machine can also have at least one automatic machine control system. This automatic control system, which can, for example, again comprise one or more data-processing devices, can be designed, for example, with program technology in order to control a cleaning operation in the automatic conveyor-type cleaning machine. By way of example, the automatic-machine control system can accordingly be designed with program technology in order to carry out one or more cleaning programs. In addition, corresponding memory media, input and output means or the like can again be provided in apparatuses which usually comprise an automatic-machine control system.

The at least one handling device can, as described above, can have at least one device control system. Thus, the at least one automatic-machine control system and the at least one device control system can be operatively connected in one direction or in both directions. Thus, operative connection can be understood to be a connection which can be made, for example, via one or more corresponding wire-bound and/or wire-free interfaces and in which data and/or parameters can be interchanged in one direction or in both directions. By way of example, these parameters may be control parameters. If, for example, the automatic conveyor-type cleaning machine is stopped, for example as a result of a fault or an interruption in machine operation caused or created by operating personnel, the device control system, for example, can accordingly also be stopped, and therefore the transfer of washware to the transportation apparatus is stopped. This is only one way of exercising influence in this direction, and it is therefore possible, for example, to also transmit other parameters to the handling device, for example the current transportation speed of the transportation apparatus or the like. As an alternative or an addition, influence can be exercised in the opposite direction, that is to say from the handling device to the automatic conveyor-type cleaning machine, for example, as described above, to match a cleaning operation in the automatic conveyor-type cleaning machine to at least one property of the washware. Thus, the operative connection can be made decentrally, or a central control system can be provided, the central control system wholly or partly comprising both the automatic-machine control system and the device control system, so that influence can be exercised in both directions between the handling device and the automatic conveyor-type cleaning machine.

As indicated above, the cleaning apparatus can be designed to identify different types of washware. In particular, the handling apparatus can be correspondingly designed. In accordance with this identification of different types of presented washware, a distinction can be drawn between these types of washware and transfer of the said washware to the transportation apparatus can be accordingly influenced. For example, it is possible for different types of washware to be sorted with the same automatic conveyor-type cleaning machine, for example in which these different types are associated with different receptacles in the transportation apparatus. The transportation operators can therefore comprise, for example, at least one of the following transportation apparatuses: a belt transportation apparatus, in particular a belt transportation apparatus having at least two different lanes and/or belt regions for different types of washware; a rack transportation apparatus, in particular a rack transportation apparatus with racks having at least two different compartments for different types of washware. Accordingly, the handling apparatus can be used to assign the various types of washware.

As such, the same handling device can also be used, for example, to handle different types of washware and to transfer the said washware to the at least one transportation apparatus. As an alternative or in addition, specialized handling devices can also be used, and therefore, for example, the cleaning apparatus comprises at least two handling devices with at least partly different tasks. Accordingly, at least two image-capturing systems can also be provided. The cleaning apparatus can then be designed to use the at least two handling devices and the at least two image-capturing systems to pick up different types of washware and to transfer the said washware to the transportation apparatus.

In addition to the said components, the cleaning apparatus can also comprise additional components. By way of example, the cleaning apparatus can also comprise at least one disposal apparatus, for example, in particular, at least one rubbish chute for waste. The cleaning apparatus can then be designed to use at least one handling device, or (when a plurality of handling devices are provided) at least one of these handling devices, and the disposal apparatus to dispose of waste contained in and/or on the washware. In this way, it is possible for food scraps in corresponding dishes to be disposed of automatically, for example. This can be done, in each case, so that disposal of this type can be performed, for example, in every case, or it is possible to identify, for example using the image-capturing system, whether disposal of this type is necessary and to perform corresponding disposal only if this is so. Furthermore, additional articles, for example serviettes or the like, can also be disposed of, or articles which are not to be disposed of (for example forgotten items of personal property) can be separated out. This is also an advantage of the described image-capturing system, since image-capturing systems of this type can distinguish between various types of additional articles which are not associated with washware.

In addition to the proposed cleaning apparatus, the invention also proposes a method for loading an automatic conveyor-type cleaning machine which, as described above, can be carried out in particular using a cleaning apparatus and/or a handling device according to one or more of the above-described embodiments. Thus, the washware can be presented to at least one handling device, with the handling device at least partly automatically picking up the presented washware and transferring said washware to at least one transportation apparatus of at least one automatic conveyor-type cleaning machine. The transportation apparatus transports the washware through at least one cleaning zone of the automatic conveyor-type cleaning machine. At least sub-tasks of the entire volume of work can again be performed by human operators, for example some of the transfer of the presented washware to the transportation apparatus. As described above, reference may be made to the corresponding developments and/or details of the described cleaning apparatus for possible details and developments of the method according to the invention. The method for loading the automatic conveyor-type cleaning machine can be extended, as described above, to a method for cleaning washware.

The proposed cleaning apparatus and the proposed method have a large number of advantages over known apparatuses and methods. Therefore, the invention presents, in particular, an apparatus and a method with which dishes and items of cutlery can be removed from food trays and can be placed, for example, on a conveyor belt or in the dish racks of a conveyor-type dishwasher. All of this can take place without a human operator having to perform strenuous, monotonous work.

At the same time, the outlined cleaning apparatus can provide a device which serves the described purpose without requiring a great deal of space and/or without a great deal of investment. At the same time, this device can be used comparatively universally. It is therefore possible to adapt to changed operating situations with only a little outlay, for example simple changes in software. This has the result that cleaning apparatuses of this type can be produced universally and can be matched to the special requirements of a specific customer with comparatively simple modifications. This adaptation can be performed at the factory and/or later during set-up. In this way, logistics costs can be reduced and the outlay on set-up can be considerably reduced too.

Furthermore, the proposed cleaning apparatuses can use the proposed methods to increase the work rate, that is to say the throughput of the cleaning apparatus. This can be attributed, in particular, to the fact that a handling device, for example a corresponding robot, can achieve a higher work rate than human operating personnel on account of advancing sensor technology and/or image-identification technology. This likewise provides strong savings potentials for the operating company of such a system.

By way of example, it is possible, as described above, to combine one or more robots with one or more image-capturing systems, possibly including corresponding image evaluation, and, for the purpose of clearing food trays, combined to form a device for communal feeding with a conveyor-type dishwasher. The advantages of such combination are, in particular, that the robot system is freely programmable in terms of its movement sequences. A robot system of this type is therefore not designed and produced individually only for one use in each case but, on account of its flexibility, is suitable for mass-production. Only minor modifications, for example in software, are then required to adapt to the respective individual case. Therefore, the proposed combination to form an overall system can increase the work rate compared to purely manual clearing. Furthermore, the proposed cleaning apparatus can complete a large volume of work over a relatively long period of time, in particular without intervals and during one shift. Overall, a robot system of this type can, taking into consideration all costs, prove to be more cost-effective for an operating company than manual clearing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic illustration of a two-station variant of a cleaning apparatus according to the conventional art with manual loading;

FIG. 1b shows a four-station variant of a cleaning apparatus according to the conventional art with manual loading;

FIG. 2 shows a schematic illustration of a typical tray in a communal feeding facility together with its possible contents;

FIG. 3 shows a schematic plan view of a conveyor belt of a conveyor-type dishwasher with a plurality of lanes and/or belt regions for different types of washware; and

FIG. 4 shows a schematic illustration of an embodiment of a cleaning apparatus according to the invention.

### DETAILED DESCRIPTION

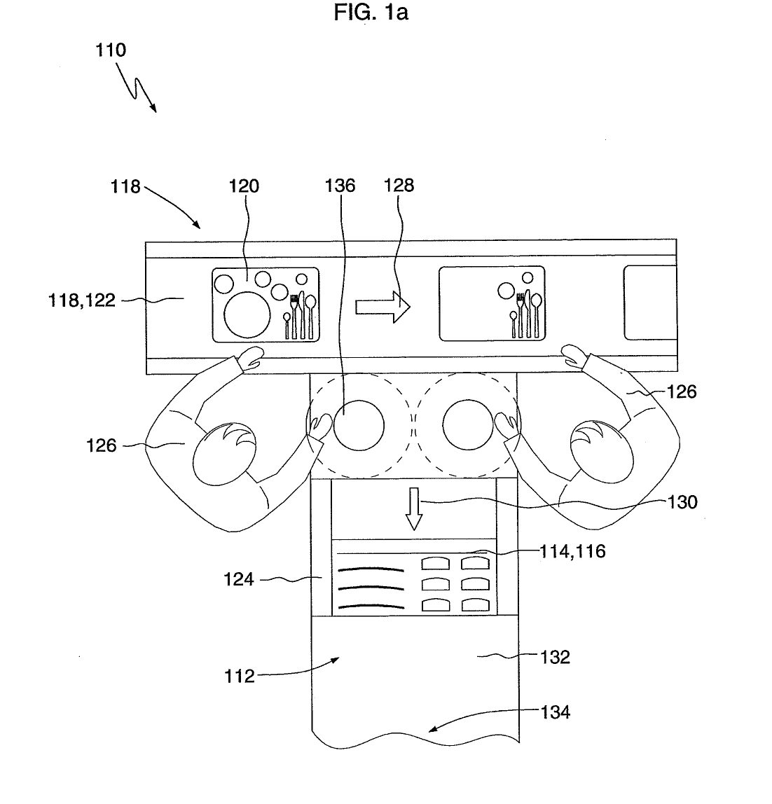

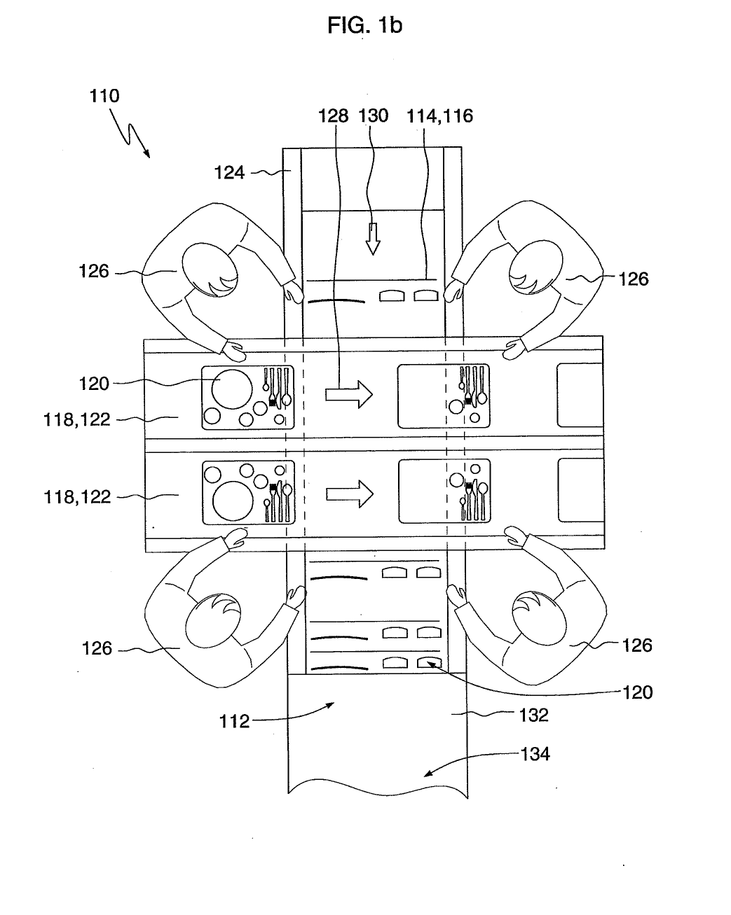

FIG. 1a schematically illustrates a plan view of a cleaning apparatus 110 according to the prior art. This cleaning apparatus 110 comprises a conveyor-type dishwasher 112 which has, as an integral or separate constituent part, an associated transportation apparatus 114. This transportation apparatus 114 may be configured in one or more parts and has, for example, a transportation belt 116.

A feed device 118 is connected upstream of the conveyor-type dishwasher 112 as a constituent part of the cleaning apparatus 110. This feed device 118, which can be configured as a conveyor device for example, serves to feed and therefore to present washware 120 to the conveyor-type dishwasher 112. The feed device 118 can comprise, for example, a simple strap belt 122, a round belt conveyor or a plate chain belt. However, other refinements are also feasible.

In association with the conveyor-type dishwasher 112, two work stations, at which operators 126 clear the washware 120 from the trays (which can likewise be associated with the washware 120) by hand and place it in the correct position on the transportation belt 116 of the conveyor-type dishwasher 112, are located at an inlet 124 to the conveyor-type dishwasher 112 in the exemplary embodiment illustrated in FIG. 1a. The washware 120 which was originally presented in a first transportation direction 128 of the feed device 118 is then conveyed into the conveyor-type dishwasher 112 or an inlet tunnel 132 of the conveyor-type dishwasher 112 in a second transportation direction 130 which is different from the first transportation direction 120 in the illustrated exemplary embodiment. One or more cleaning zones 134 in which the washware 120 is sequentially cleaned can be arranged downstream of the inlet tunnel 132, as indicated in FIGS. 1a and 1b. Various refinements are feasible.

In the exemplary embodiment illustrated in FIG. 1a, waste and/or food scraps which are contained on the tray or in other types of washware 120 are placed, likewise by hand, into rubbish chutes 136 intended for the said waste. Rubbish chutes 136 of this type could also be provided in the example according to FIG. 1b.

In the sequence illustrated in FIG. 1a for example, each operator 126 performs only individual or only a few subtasks. The trays cleared of washware 120 can, for example, be conveyed onward, for example to a separate tray-washer which is not illustrated in FIG. 1a and which can likewise be a constituent part of the cleaning apparatus 110 for example. However, embodiments in which the trays are transported in a dedicated lane through the same conveyor-type dishwasher 112 as the dishes and the cutlery and cleaned in the said conveyor-type dishwasher are likewise known.

In contrast to the exemplary embodiment with two operators 126 illustrated in FIG. 1a, FIG. 1b shows, likewise in plan view, a schematically illustrated embodiment in which four work stations for operators 126 are located at the inlet 124 to the conveyor-type dishwasher 112. In this example which likewise corresponds to the prior art too, the washware 120 is also cleared by hand from the trays which can be associated with the washware 120 again and placed in the correct position on the transportation belt 116 of the conveyor-type dishwasher 112. Therefore, the cleared tray can, for example, again be conveyed further, for example to a separate tray-washer, or the tray can also be cleaned in the same conveyor-type dishwasher 112. In other respects, reference may be made largely to the description of FIG. 1a for further details of the exemplary embodiment illustrated in FIG. 1b.

The four-station variant illustrated in FIG. 1b is generally selected when so many dishes have to be sorted and washed that two operators 126 are no longer able to handle the quantities. Variants in which only one operator 126 is used are likewise encountered in practice. Furthermore, reference is to be made to the fact that the arrangements according to FIGS. 1a and 1b are to be understood merely as examples, and it is therefore possible, for example, for the individual functional elements at the dish deposit point to be arranged in a spatially different manner than in the examples shown according to FIGS. 1a and 1b.

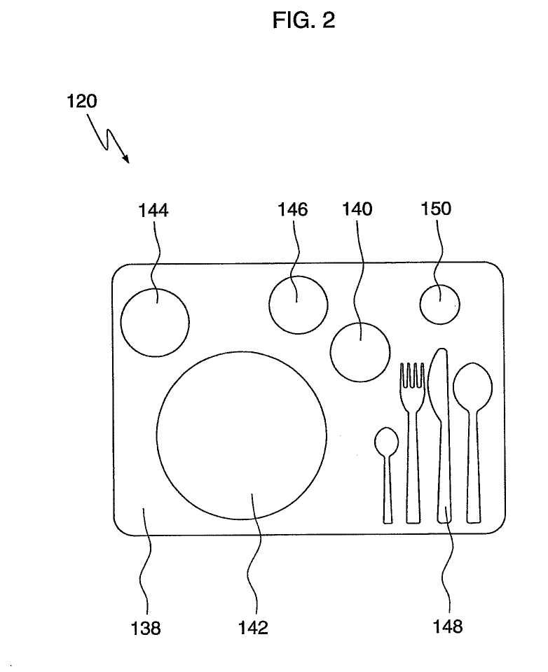

The illustration according to FIG. 2 schematically shows one possible arrangement of washware 120 as is frequently encountered in the field of dishwashing. However, it should be noted that the individual components of this washware 120 may be present distributed in virtually any manner. In this respect, the distribution illustrated by way of example in FIG. 2 is considered to be ideal, and the cleaning apparatus 110 should also be able to handle other distributions of any type.

In FIG. 2, reference numeral 138 denotes a tray, for example a plastic or wooden tray. This tray 138 can, in principle, be of any desired shape but is generally of rectangular design, as illustrated in FIG. 2. Furthermore, a soup bowl 140, a plate 142, a salad bowl 144, a dessert bowl 146, cutlery 148 and a drinking glass 150 are provided on the tray 138 in the illustrated exemplary embodiment. All the articles are merely symbolically indicated. As can be seen in FIG. 2, it is also possible, in addition to virtually any random distribution of the individual articles of washware 120, for numerous different forms and/or materials of washware 120 to be present, this washware having to be reliably and safely handled by the cleaning apparatus 110.

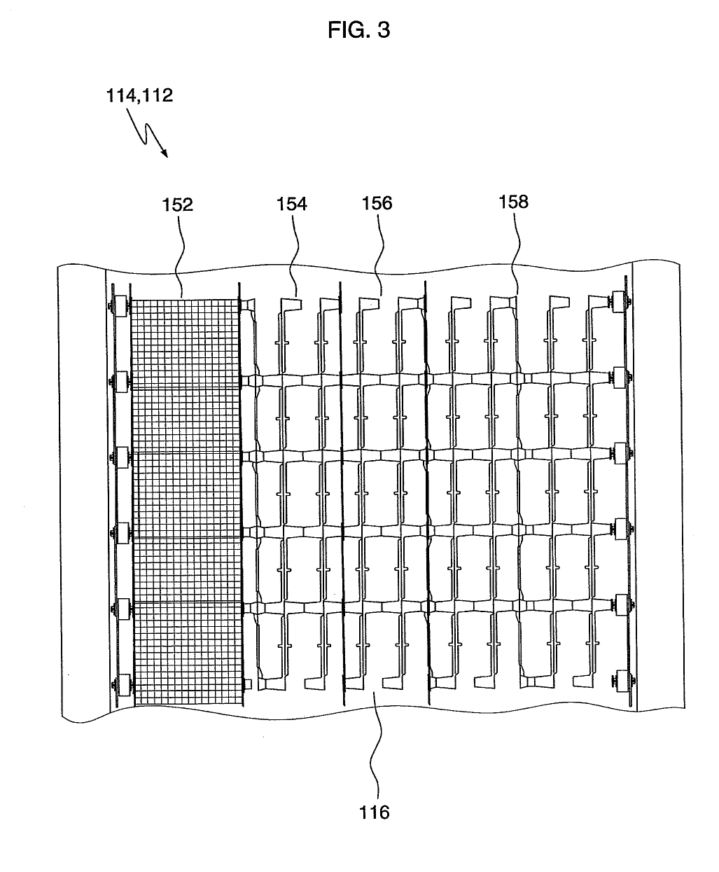

FIG. 3 illustrates, by way of example, an exemplary embodiment of a transportation apparatus 114 of a cleaning apparatus 110 according to the prior art. This transportation apparatus 114 may also be used within the scope of the present invention and is intended to solve a further problem of automatic loading of the conveyor-type dishwasher 112 with washware.

The transportation apparatus 114 again has a transportation belt 116, for example a conveyor belt. Here in the present case, this conveyor belt of the conveyor-type dishwasher 112 is divided into a plurality of lanes and/or belt regions (both expressions are used synonymously in the text which follows) for different types of washware 120. While reference numeral 116 denotes the entire transportation belt, reference numeral 152 denotes a lane for cutlery 148, reference numeral 154 denotes a lane for bowls (for example the salad bowl 144 and/or the dessert bowl 146 according to FIG. 2), reference numeral 156 denotes a lane for plates 142 and reference numeral 158 denotes a lane for trays 138. However, this arrangement according to FIG. 3 is likewise to be considered merely as an example. Other refinements of the transportation apparatus 114 are also feasible, for example arrangements in which the washware 120 is transported by means of racks or the like.

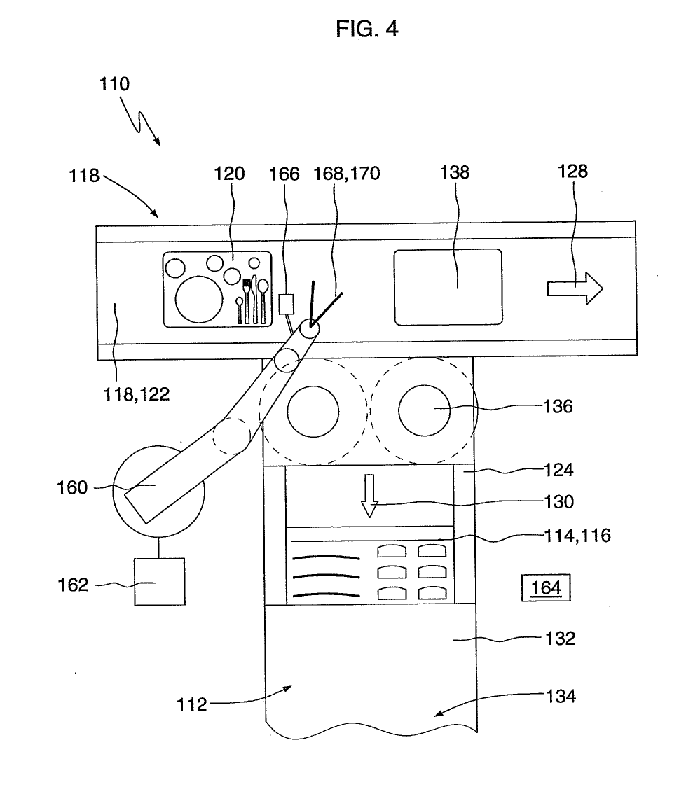

FIG. 4 illustrates a schematic plan view of one possible exemplary embodiment of a cleaning apparatus 110 according to the invention. The exemplary embodiment corresponds in many details to the exemplary embodiments according to FIGS. 1a and 1b, and therefore reference may be made, for example, to the above description of the said figures with regard to the functioning of the individual elements and the possible design of the said elements. The cleaning apparatus 110 again comprises a conveyor-type dishwasher 112 having a transportation apparatus 114 with a conveyor belt 116. Furthermore, a feed device 118 which presents washware is again provided, likewise again approximately perpendicular to the transportation apparatus 114. However, other arrangements of the transportation apparatus 114 and/or of the feed device 118 are possible in principle.

The feed device 118 is connected upstream of the conveyor-type dishwasher 112 in order to feed washware 120. The feed device 118 may comprise, for example, a strap belt 122, a round belt conveyor or a plate chain belt. However, other refinements are again also feasible.

In the exemplary embodiment illustrated in FIG. 4, the cleaning apparatus 110 comprises a handling device 160 in the region of the inlet 124. This handling device 160 can be used universally and can be configured for example, as a robot, as a multiple-axis robot, as a multiple-axis articulated-armed robot, or in a similar way. The handling device comprises a device control system 162 which can be designed separately from or partly identically to an automatic-machine control system 164 of the conveyor-type dishwasher 112. Centralized control of the entire cleaning apparatus 110 is also feasible. Furthermore, the control systems 162, 164 can be operatively connected, for example via one or more interfaces (not illustrated in FIG. 4).

Furthermore, the cleaning apparatus 110 in the exemplary embodiment illustrated in FIG. 4 comprises an image-capturing system 166. Here in FIG. 4, this image-capturing system 166 is illustrated as a constituent part of the handling device 160. However, other refinements are also possible in principle, for example an arrangement in which the image-capturing system 166 is separate and/or is associated with a plurality of handling devices 160. The image-capturing system 166 can be designed to also at least partly perform an image-processing operation, that is to say, for example, to visually detect at least one property of the washware 120, for example the simple presence of the washware 120 and/or the orientation of the washware 120. Further examples have been described above.

The handling device 160 further comprises a pick-up apparatus 168 which is illustrated as a grabber 170 in this exemplary embodiment. However, other embodiments are again also possible. The image-capturing system 166 and/or the image-processing system contained therein can be used by the handling device 160 or the cleaning apparatus 110 to identify, for example, the presence of washware 120, for example the fact that a new, loaded, partially loaded or unloaded tray 138 is presented by the feed device 118. Furthermore, a load on this tray 138 can also be identified, for example in accordance with the illustration in FIG. 2. The device control system 162 can then prompt the handling device 160, for example the robot, to carry out the required movements and actions in order to fulfil the set task of transferring washware to the transportation apparatus 114. The pick-up apparatus 168, for example the grabber 170, can be used to pick up, for example, the dishes 140, 142, 144, 146, 150 and/or the cutlery 148 from the tray 138 and place said dishes in the correct position on the transportation belt 116 of the conveyor-type dishwasher 112. Thus, the pick-up apparatus 168 can comprise, for example, as illustrated in FIG. 4, a mechanical grabber 170 or, as an alternative or in addition, a pneumatic grabber, in particular a suction cup, a magnetic grabber, in particular for picking up the cutlery 148, or a combination of such pick-up apparatuses and/or other types of pick-up apparatuses 168.

As, according to the prior art, each operator 126 already assumes individual sub-tasks or only a few sub-tasks in the case of large clearing stations with manual operator control, a procedure of this type can be applied, in principle, in a robot-assisted dish-clearing means according to the FIG. 4 or according to other embodiments of the invention. This can mean that a plurality of handling devices 160, for example a plurality of removal robots, can be used in cleaning apparatuses 110, for example starting from a specific size and/or capacity.

It is equally feasible for the one handling device 160 or the plurality of handling devices 160 to not pick up all the existing articles which are presented by the feed device 118 and transfer the said articles to the transportation apparatus 114, but only for sub-tasks to be performed by the handling devices 160. For example, in addition to the existing handling devices 160, one or more human operators 126 can be used, for example in order to remove the remaining leavings (for example articles not identified by the handling device 160) from the tray 138 and accordingly dispose of said leavings.

It is also conceivable for the handling device 160, in particular the robot, to use its image-capturing system 166 to acquire information about a property, for example the type, of the washware. For example, it is possible to identify that the dishes in the device for communal feeding are only slightly soiled breakfast dishes. As an alternative or in addition, washware which is particularly difficult to clean could also be identified, for example pots and pans or the like. This information could be passed on by the device control system 162 of the handling device 160 to the automatic-machine control system 164 of the conveyor-type dishwasher 112, so that the automatic-machine control system 164 of the conveyor-type dishwasher 112 can accordingly exercise influence on the parameters of dishwasher operation. A change in the belt speed of the transportation belt 160, a temperature in individual cleaning zones 134, special detergent additives or the like may be mentioned here as examples.

In a departure from the conveyor-type dishwashers 112 in the form of belt-transportation machines cited in the examples, it is also possible to use the described invention, as illustrated above, in other types of automatic conveyor-type cleaning machines, for example in rack transportation dishwashers.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning apparatus for cleaning washware, in particular dishes, the cleaning apparatus comprising:
at least one automatic conveyor-type cleaning machine having at least one transportation apparatus and configured to transport the washware through at least one cleaning zone; and
at least one handling device configured to at least partly automatically pick up presented washware and transfer the washware to the transportation apparatus.

2. The cleaning apparatus according to claim 1, further comprising a feed device configured to feed the washware to the automatic conveyor-type cleaning machine, wherein the handling device is configured to automatically pick up the washware from the feed device and transfer the washware to the transportation apparatus.

3. The cleaning apparatus according to claim 2, wherein the feed device comprises at least one of the following feed devices: a conveyor belt, a strap belt, a round belt conveyor, a chain belt, or a plate chain belt.

4. The cleaning apparatus according to claim 2, wherein the cleaning apparatus comprises at least two automatic conveyor-type cleaning machines, and wherein the feed device is configured to provide the washware to the two automatic conveyor-type cleaning machines.

5. The cleaning apparatus according to claim 4, wherein at least one handling device is associated with each automatic conveyor-type cleaning machine.

6. The cleaning apparatus according to claim 1, wherein the handling device comprises at least one of the following pick-up apparatuses for picking up the presented washware: a mechanical pick-up apparatus, a grabber, a magnetic pick-up apparatus, a pneumatic pick-up apparatus, at least one suction device, and/or at least one suction cup.

7. The cleaning apparatus according to claim 1, wherein the handling device is configured as a freely programmable handling device.

8. The cleaning apparatus according to claim 1, wherein the handling device is configured as a handling device with at least two degrees of freedom for movement, or wherein the handling device is configured as a handling device with three or more degrees of freedom.

9. The cleaning apparatus according to claim 1, wherein the cleaning apparatus and/or the handling device has at least one sensor for detecting the presented washware.

10. The cleaning apparatus according to claim 1, wherein the cleaning apparatus and/or the handling device comprises at least one image-capturing system, the image-capturing system being configured to identify the washware, wherein the cleaning apparatus is configured to control pick-up the washware via the handling device and/or transfer the washware to the transportation apparatus based on a type of the washware being identified by the image-capturing system.

11. The cleaning apparatus according to claim 10, wherein the cleaning apparatus is configured to control a cleaning process of the washware in the automatic conveyor-type cleaning machine based on a degree of soiling of the washware which is identified by the image-capturing system.

12. The cleaning apparatus according to claim 1, further comprising a plurality of handling devices and/or a plurality of image-capturing systems, the plurality of handling devices and/or the plurality of image-capturing systems being controlled and/or supplied with power by a common device control system.

13. The cleaning apparatus according to claim 1, further comprising at least one automatic-machine control system, wherein the handling device includes at least one device control system, and wherein the automatic-machine control system and the device control system are operatively connected in one direction or in both directions.

14. The cleaning apparatus according to claim 1, wherein the cleaning apparatus is configured to distinguish between different types of presented washware and is configured to transfer the washware to the transportation apparatus in accordance with a type of washware that is identified.

15. The cleaning apparatus according to claim 1, wherein the transportation apparatus comprises at least one of the following transportation apparatuses: a belt transportation apparatus, a belt transportation apparatus having at least two different lanes and/or belt regions for different types of washware, a rack transportation apparatus, or a rack transportation apparatus with racks having at least two different compartments for different types of washware.

16. The cleaning apparatus according to claim 1, further comprising at least two handling devices and at least two image-capturing systems, wherein the cleaning apparatus is configured to use the at least two handling devices and the at least two image-capturing systems to pick up different types of washware and transfer the washware to the transportation apparatus.

17. The cleaning apparatus according to claim 1, further comprising at least one disposal apparatus or at least one rubbish chute for waste, wherein the cleaning apparatus is configured to use the handling device and the disposal apparatus to dispose of waste contained in and/or on the washware.

18. A method for loading an automatic conveyor-type cleaning machine, in particular a conveyor-type dishwasher, with washware using a cleaning apparatus according to claim 1, the method comprising:
providing the washware on at least one handling device, the handling device at least partly automatically picking up the presented washware; and
transferring the washware to at least one transportation apparatus of the automatic conveyor-type cleaning machine, which transportation device transports the washware through at least one cleaning zone of the automatic conveyor-type cleaning machine.

19. The method according to claim 18, wherein the washware is cleaned in at least one cleaning step in the automatic conveyor-type cleaning machine.

20. The cleaning apparatus according to claim 1, wherein the at least one automatic conveyor-type cleaning machine is a conveyor-type dishwasher, wherein the at least one handling device is a robot.
